(19) United States
(12) Patent Application Publication
(10) Pub. No.: US 2019/0017802 A1
(43) Pub. Date: Jan. 17, 2019

(54) OPTICAL SENSING DEVICE FOR WHEEL SET AND OPTICAL SENSING METHOD USING THE SAME

(71) Applicant: INDUSTRIAL TECHNOLOGY RESEARCH INSTITUTE, Hsinchu (TW)

(72) Inventors: Shao-Yu LEE, HSINCHU COUNTY (TW); Chia-Jui HU, New Taipei City (TW); Pin-Yung CHEN, Hsinchu City (TW); Yi-Ling LIN, Taichung City (TW); Chin-Chang CHEN, Hsinchu City (TW)

(21) Appl. No.: 15/811,285

(22) Filed: Nov. 13, 2017

(30) Foreign Application Priority Data
Jul. 17, 2017 (TW) 106123799

(51) Int. Cl. G01B 9/02

(52) U.S. Cl. CPC G01B 9/02015; G01B 9/02034

(57) ABSTRACT

An optical sensing device for a wheel set is provided. The optical sensing device comprises a first grating, a second grating, an elastic object and two optical sensors. The first grating is set in a first wheel of the wheel set. The second grating is set in a second wheel of the wheel set. The elastic object is connected between the first wheel and the second wheel, and is adapted to sustain a force applied when an angle difference is formed by a rotation of the second wheel with respect to the first wheel. The two optical sensors are set in a power module of the wheel set and provided respectively in correspondence to the first and the second gratings. The two optical sensors receive two optical signals reflected by the first and the second gratings, and the two optical sensors are used to calculate the angle difference.

This Application claims the benefit of Taiwan Application Serial No. 106123799, filed Jul. 17, 2017, the disclosure of which is incorporated by reference herein in its entirety.

### TECHNICAL FIELD

The technical field relates to a sensing device, and particularly to an optical sensing device for a wheel set and an optical sensing method using the same.

### BACKGROUND

In the field of power-assisted wheels, to detect a user's intention, it is common to set a sensor for detecting change in force or angle between a hand wheel and a road wheel. Using a contact type sensor to measure will encounter a problem of relative movement between a measurement end and a signal processing end, and thus requiring elements like a brush or slip ring to communicate signals between rotating elements (wheels and sensors thereon) and non-rotating elements (a power module). It is easy to wear off or face a problem of poor communication after using this kind of products for a while.

On the other hand, if the power module is detachable, the contact type sensor has other issues, such as problem in alignment or durability. A solution to the alignment or durability problem is to use non-contact sensing method; however, most of non-contact sensing methods rely on magnetic elements, which suffer from being hard to assemble and too heavy if high precision is required, or being with low sensing precision if less weight is required.

### SUMMARY

The present disclosure relates to an optical sensing device for a wheel set and an optical sensing method using the same. The method is non-contact sensing method and the sensor is set in the power module.

According to one embodiment, an optical sensing device for a wheel set is provided. The optical sensing device comprises a first grating, a second grating, an elastic object and two optical sensors. The first grating is set in a first wheel of the wheel set. The second grating is set in a second wheel of the wheel set. The elastic object is connected between the first wheel and the second wheel, and the elastic object is adapted to sustain a force applied when an angle difference is formed by a rotation of the second wheel with respect to the first wheel. The two optical sensors are set in a power module of the wheel set and provided in correspondence to the first grating and the second grating respectively. The two optical sensors receive two optical signals reflected by the first grating and the second grating respectively, and the two optical sensors are used to calculate the angle difference.

According to another embodiment, an optical sensing method for a wheel set is provided. The wheel set comprises a first wheel, a second wheel, and a power module, wherein a first grating is set in the first wheel, a second grating is set in the second wheel, and two optical sensors are set in the power module. The optical sensing method comprises the following steps. The two optical sensors receive two optical signals reflected by the first grating and the second grating respectively. An angle difference formed by the rotation of the second wheel with respect to the first wheel is calculated according to the two optical signals reflected by the first and the second gratings.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is an explosion diagram of a wheel set having a power module according to an embodiment of the disclosure.

FIG. 2A is a schematic diagram of a first grating and a second grating for optical sensing according to an embodiment of the disclosure.

FIGS. 2B and 2C are schematic diagrams showing there are a positive angle difference (Δθ>0) and a negative angle difference (Δθ<0) between the first and the second gratings of FIG. 2A respectively.

FIG. 3A is a schematic diagram for analyzing a phase change of an optical signal reflected by the second grating according to an embodiment of the disclosure.

FIG. 3B is a schematic diagram of signals in correspondence to different phase time S1 to S4 of FIG. 3A.

FIG. 4 is a flow chart of an optical sensing method for a wheel set according to an embodiment of the disclosure.

FIG. 5A is a schematic diagram of an optical sensing device for a wheel set according to an embodiment of the disclosure.

FIG. 5B is an explosion diagram of an optical sensing device for a wheel set according to another embodiment of the disclosure.

FIG. 5C is an explosion diagram of an optical sensing device for a wheel set according to yet another embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Detailed descriptions of the invention are disclosed below with a number of embodiments. However, the disclosed embodiments are for explanatory and exemplary purposes only, not for limiting the scope of protection of the disclosure.

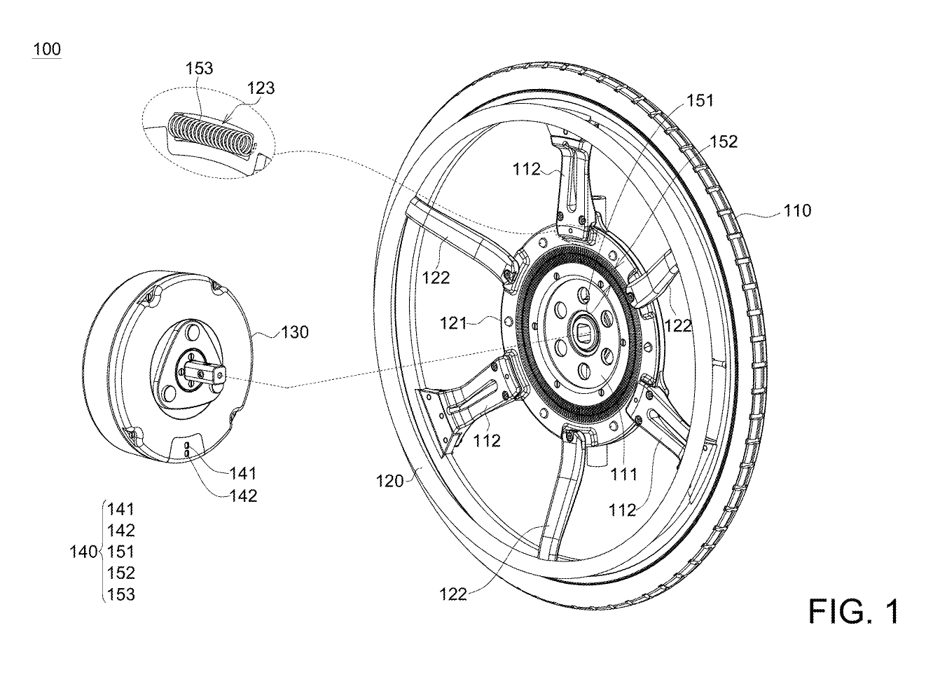

Please refer to FIG. 1. A wheel set 100 comprises a first wheel 110, a second wheel 120, a power module 130 and an optical sensing device 140. The first wheel 110 is a road wheel which can be power-assisted, and the second wheel 120 is a hand wheel which can be rotated by a hand of a user. When the user rotates the second wheel 120, the optical sensing device 140 detects the user's intention, including force applied by the user and the direction of rotation of the second wheel 120; thereby, the power module 130 drives the first wheel 110 to rotate accordingly.

Please refer to FIG. 1. The wheel 110 has a wheel hub 111 and a plurality of spokes 112. The second wheel 120 has a circular plate 121 which may rotate with respect to the wheel hub 111, and a plurality of spokes 122 connected to the circular plate 121.

In one embodiment, the wheel set 100 may apply to transportation equipment such as an electric wheelchair or an electric bicycle. Further, the wheel set 100 with the power module detached still works as an ordinary wheel, and there is no need to detach the road wheel from the electric wheelchair or electric bicycle.

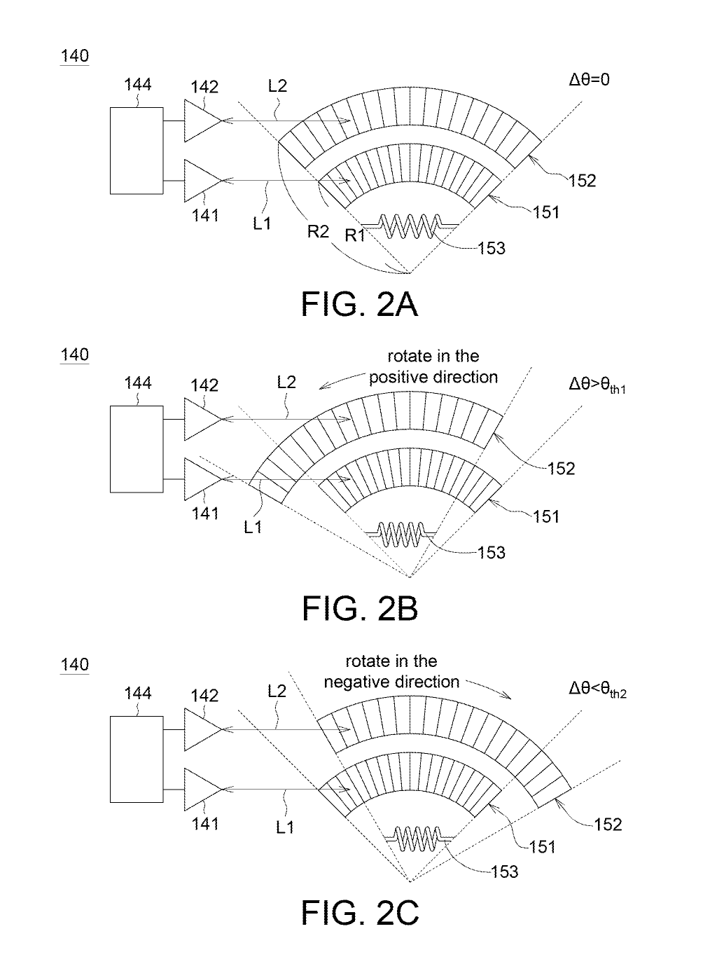

Please refer to FIG. 1, and FIGS. 2A-2C. According to one embodiment of the disclosure, the optical sensing device 140 for the wheel set 100 comprises a first grating 151, a second grating 152, an elastic object 153 and two optical sensors 141 and 142. The first grating 151 may be set in the first wheel 110 of the wheel set 100 as shown in FIG. 1. The second grating 152 may be set in the second wheel 120 of the wheel set 100 as shown in FIG. 1.

The first grating 151, for instance, has a plurality of lines with same widths and equally spaced, and the lines are arranged on the radial surface of the wheel hub 111. The second grating 152, for instance, has a plurality of lines with same widths and equally spaced, and the lines are arranged on the radial surface of the circular plate 121. That is, the first grating 151 and the second grating 152 have the same center of a circle. The first grating 151 has a first radius R1 with respect to the center and the second grating 152 has a second radius R2 with respect to the same center, as shown in FIG. 2. In one example, the first radius R1 is smaller than the second radius R2, which means the first grating 151 is closer to the center than the second grating 152. In another example, which is not shown, the first radius R1 is larger than the second radius R2, which means the second grating 152 is closer to the center than the first grating 151. However, the disclosure is not limited thereto

Further, please refer to FIG. 1. The elastic object 153 is set between the first wheel 110 and the second wheel 120. The elastic object 151 is adapted to sustain a force applied when an angle difference is formed by a rotation of the second wheel 120 with respect to the first wheel 110. That is, when the user rotates the second wheel 120 to some degree, the elastic object 151 is compressed or extended and thus produces an elastic recovery force. When the user let go of the second wheel 120, the second wheel 120 will resume to its' initial position because of the elastic recovery force. The elastic object 153, for instance, may be a coil spring or torsion spring, and the elastic object 153 has an elastic modulus. In one embodiment, the force applied by the user to the second wheel 120 can be calculated by multiplying the elastic modulus with a displacement caused by compression or extension of the elastic object 153. The number of the elastic object 153 is not limited to one or more. In one embodiment, there are three elastic objects 153, for instance.

Please refer to FIG. 1. In one embodiment, the elastic object 153 is in a groove 123 between the wheel hub 111 and the circulate plate 121. When the second wheel 120 rotates with respect to the first wheel 110, the elastic object 153 in the groove 123 may be compressed (as shown in FIGS. 2B and 2C) or released to its' initial state without compression (as shown in FIG. 2A).

Further, please refer to FIG. 1. The two optical sensors 141 and 142 are set in the power module 130 of the wheel set 100. The optical sensors 141 and 142 are provided in correspondence to the first grating 151 and the second grating 152 respectively. The two optical sensors 141 and 142 each sends out an optical signal and receives optical signals L1 and L2 reflected by the first grating 151 and the second grating 152 respectively. The reflected optical signals L1 and L2 are pulse signals. The pulse signal represents the number of lines which passes the optical signals per unit time. Therefore, one can get the number of lines of the gratings by counting the pulse frequencies of the reflected optical signals L1 and L2. Because the optical sensors 141 and 142 use non-contact sensing method, the elements, without wearing off caused by physical contact, are much more durable. In addition, the optical sensors 141 and 142 and a module for receiving sensing signals, such as a determination element 144, may be set in the power module 130. If the power module 130 has a quick release mechanism, the power module 130 may be easy to detach, thus solving the problem existing in conventional contact type sensors, which have the tendency to wearing off and being not detachable.

Please refer to FIG. 2A to FIG. 2C. The optical sensing device 140 further comprises a determination element 144 (e.g. a controller) for receiving sensing signals output from the two optical sensors 141 and 142 to calculate the numbers of lines of the first and the second gratings 151 and 152 and calculating a first angle and a second angle in correspondence to the numbers of lines of the first and second gratings 151 and 152 respectively. The first angle is an angle through which the first grating 151 rotates and the second angle is an angle through which the second grating 152 rotates. The difference between the first angle and the second angle is the angle difference Δθ produced by a rotation of the second wheel 120 with respect to the first wheel 110. That is, the angles of rotation of the first and second wheels are detected by using the numbers of lines sensed through the two optical signals. In other words, the more the numbers of the lines are, the bigger the angles of rotation are. For example, as the numbers of lines increase by 1, the angle of rotation increases by 0.25 degrees; therefore, by counting the numbers of the lines, the angle of rotation of the first grating 151 of the first wheel 110 and the angle of rotation of the second grating 152 of the second wheel 120 are known.

Please refer to FIGS. 1 and 2A. In one embodiment, when the second wheel 120 and the first wheel 110 rotate simultaneously, the elastic object 153 rotates at the same time too so it will not be extended or compressed. In the meantime, the numbers of lines of the first grating 151 and the second grating 151, which are sensed by the two optical sensors 141 and 142, are the same. That is, the first grating 151 and the second grating 152 rotate simultaneously so the angles of rotation of the first grating 151 and the second grating 152 are the same, which indicates there is no angel difference between the second wheel 120 and the first wheel 110 (40=0).

In FIGS. 1, 2B, and 2C, when the second wheel 120 are turned by the user and the first wheel 110 does not rotate simultaneously, the elastic object 153 are forced to be extended or compressed. In the meantime, the numbers of lines of the first grating 151 and the second grating 152, sensed by the two optical sensors 141 and 142, are not the same. That is, the first grating 151 and the second grating 152 do not rotate simultaneously so the angles of rotation of the first grating 151 and the second grating 152 are not the same, which means there is an angle difference (Δθ>0 or Δθ<0) between the second wheel 120 and the first wheel 110.

The circumstance that there is an angle difference Δθ because the first wheel 110 and the second wheel 120 do not rotate simultaneously depends on how the user operates the wheel set 100. In one embodiments, when the wheel set 100 keeps moving (forward or backward), the first wheel 110 and the second wheel 120 have the same directions of rotation (both rotating in positive or negative direction). For example, if the numbers of the lines of the first grating 151 and the second grating 152 sensed by the two optical sensors 141 and 142 are 2 and 20, respectively, than the difference between the two lines is 18 (coming from 20−2=18), and the corresponding angle difference Δθ is 9 degrees (coming from 18*0.25=9). In another embodiment, any wheel of the wheel set 100 may make a change about its' direction of rotation while the wheel set 100 is in operation, such as in a circumstance an emergency stop happens. In such circumstance, the first wheel 110 keeps rotating in the positive direction, but the direction of rotation of the second wheel 120 changes from the positive direction to the negative direction, for example, the number of lines of the first grating 151 sensed by the optical sensor 141 is 2, the number of lines of the second grating 152 sensed by the optical sensor is 5 forward and then 15 backward (and the total number is 20); however, when counting the difference between the lines of the first grating 151 and the second grating 152, it is the total “accumulated” needs to be consider, and therefore, the difference between the lines is −12 (coming from 95−150−2=−12), and the corresponding angle difference Δθ is −3 degrees (coming from −12*0.25=−3).

Please refer to FIGS. 1 and 2B. When the difference between the first angle and the second angle (i.e. the angle difference Δθ) is greater than a positive threshold θₜₕ₁, the power module 130 may output a positive torsional force to the first wheel 110 according to the angle difference Δθ to let the first wheel 110 rotates in the positive direction. The torsional force output by the power module 130 is proportional to the angle difference Δθ to embody the user's intention. Please refer to FIGS. 1 and 2C, when the user rotates the second wheel 120 reversely, causing the difference between the first angle and the second angle (i.e. the angle difference Δθ) is less than a negative threshold θₜₕ₂, the power module 130 may output a negative torsional force to the first wheel 110 according to the angle difference Δθ to let the first wheel 110 rotates in the negative direction. The positive threshold θₜₕ₁ may be great than or equal to zero, and the negative threshold θₜₕ₂ may be less than or equal to zero. When the angle difference Δθ is between the positive threshold θₜₕ₁ and the negative threshold θₜₕ₂, the power module 130 may be set not to output any torsional force to the first wheel 110. The positive threshold θₜₕ₁ may be set to be 4 degrees or more and the negative threshold θₜₕ₂ may be set to be −4 degrees or less. That is, when the angle difference Δθ is between 4 degrees to −4 degrees, there is no torsional force output to avoid accidentally action. However, the disclosure is not limited thereto.

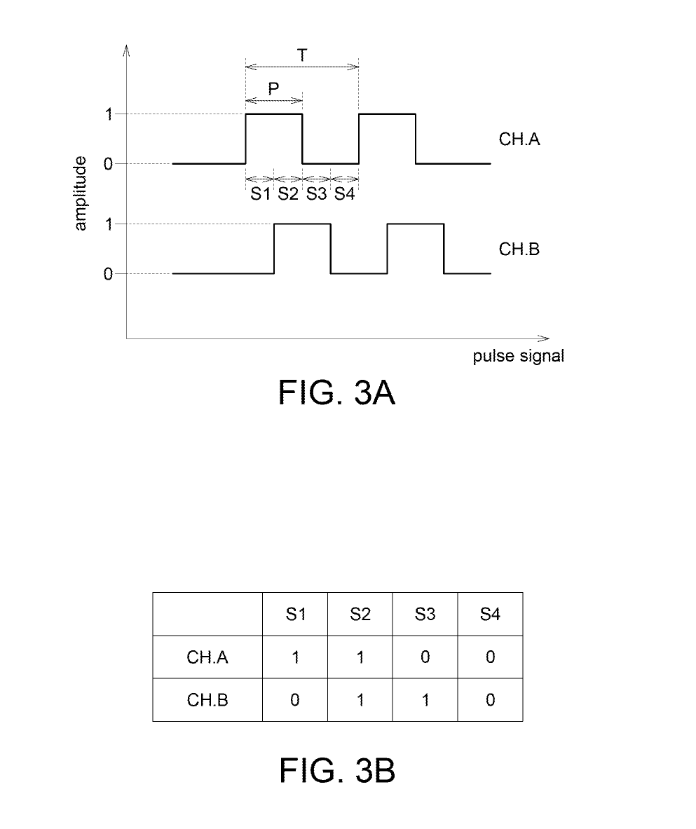

Please refer to FIG. 2A to FIG. 2C. The determination element 144 may be used to analyze a phase change of optical signal reflected by the second grating 152 for determining a direction of rotation of the second wheel 120. To be specific, please refer to FIGS. 3A and 3B, wherein P means pulse width, T means pulse period, S1 means a first phase time, S2 means a second phase time, S3 means a third phase time, S4 means a fourth phase time, CH. A means a pulse signal received by a first channel of the optical sensor 142, CH. B means a pulse signal received by a second channel of the optical sensor 142, and the CH. A pulse signal and the CH. B pulse signal differ in phase by one-quarter cycle. Please refer to FIG. 3B. In the first phase time S1, amplitudes of the CH. A pulse signal and the CH. B pulse signal are represented by (1,0). In the second phase time S2, amplitudes of the CH. A pulse signal and the CH. B pulse signal are represented by (1,1). In the third phase time S3, amplitudes of the CH. A pulse signal and the CH. B pulse signal are represented by (0,1). In the fourth phase time S4, amplitudes of the CH. A pulse signal and the CH. B pulse signal are represented by (0,0). In FIG. 2B, when the second wheel 120 rotates in the positive direction, the determination element 144 calculates the numbers of lines of the second grating 152, and determines the direction of rotation of the second wheel 120 is the positive direction since the phases in correspondence to the CH. A pulse signal and the CH. B pulse signal in FIG. 3B changes from S1 to S4. Further, in FIG. 2C, when the second wheel 120 rotates in a negative direction, the determination element 144 calculates the numbers of lines of the second grating 152, and determines the direction of rotation of the second wheel 120 is the negative direction since the phases in correspondence to the CH. A pulse signal and the CH. B pulse signal in FIG. 3B changes from S4 to S1. Besides, the determination element 144 may be used to determine the direction of rotation of the first wheel 110 by analyzing a phase change of optical signal reflected by the first grating 151. The determining process for the first wheel 110 is similar to the above-mention process for the second wheel 120 and will not be repeated to avoid redundancy. Therefore, the determination element 144 may determine the directions of rotation of the first wheel 110 and the second wheel 120 from the phase changes as mentioned.

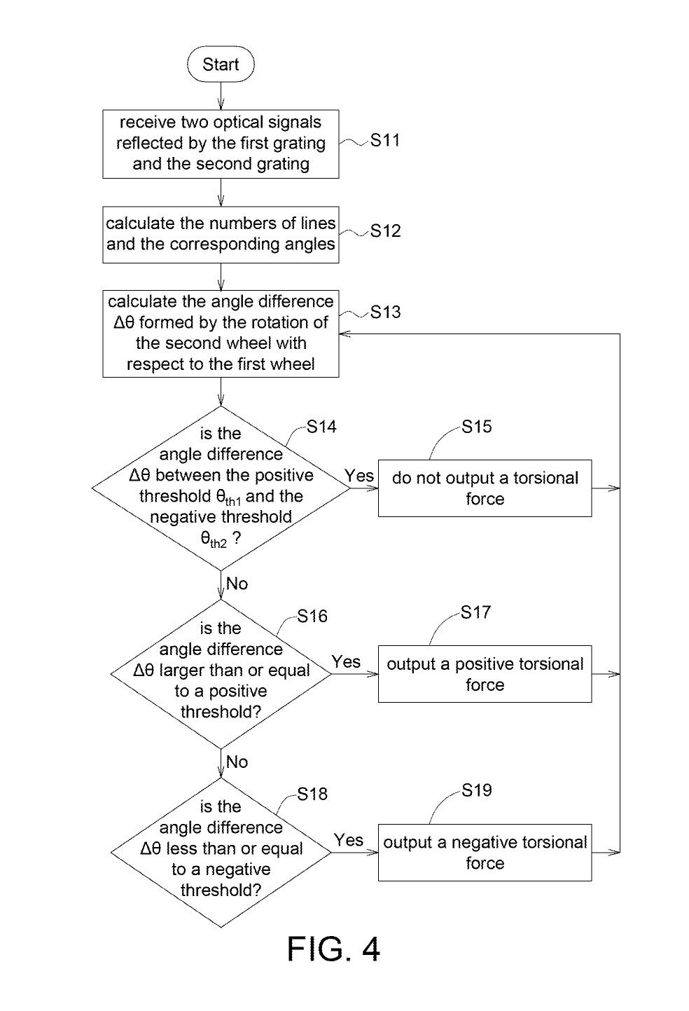

Please refer to FIGS. 1 and 4. According to one embodiment of the disclosure, the optical sensing method for a wheel set 100 comprises the following steps S11˜S18. In step S11, the two optical sensors 141 and 142 receive the two optical signals L1 and L2 reflected by the first grating 151 and the second grating 152 respectively, and the direction of rotation of the second wheel 120 is determined by the optical signal L2 reflected by the second grating 152. Please refer to the description related to FIGS. 3A and 3B for the details of determining the direction of rotation of the second wheel 121 and the contents will not be repeated here. In step S12, calculate the numbers of lines of the first grating 151 and the second grating 152 and the angles in correspondence to the numbers of lines of each grating. Further, in step S13, calculate an angle difference formed by the rotation of the second wheel 120 with respect to the first wheel 110 according to the difference between the numbers of lines of the first grating 151 and the second grating 152. For instance, the difference between the numbers of lines of these gratings increases by 1, the angle difference Δθ increases by 0.25 degrees. Similarly, the difference between the numbers of lines of these gratings decreases by 1, the angle difference Δθ decreases by 0.25 degrees.

Please refer to the description related to FIG. 2A to FIG. 2C for the calculating details of steps S12 and S13, and the contents will not be repeated here. Next, in step S14, when the angle difference Δθ is between the positive threshold θₜₕ₁ and the negative threshold θₜₕ₂, proceed to step S15, in which the power module 130 does not output an torsional force to the first wheel 110. Next, in steps S16-S17, when the angle difference is greater than or equal to the positive threshold θₜₕ₁, which means the second wheel 120 is pushed forward, the power module 130 output a positive torsional force to the first wheel 110 accordingly to rotate and move the first wheel 110 forward. On the contrary, in steps S18-S19, when the angle difference is less than or equal to the negative threshold θₜₕ₂, which means the second wheel 120 is pushed backward, the power module 130 output a negative torsional force to the first wheel 110 accordingly to rotate and move the first wheel 110 backward.

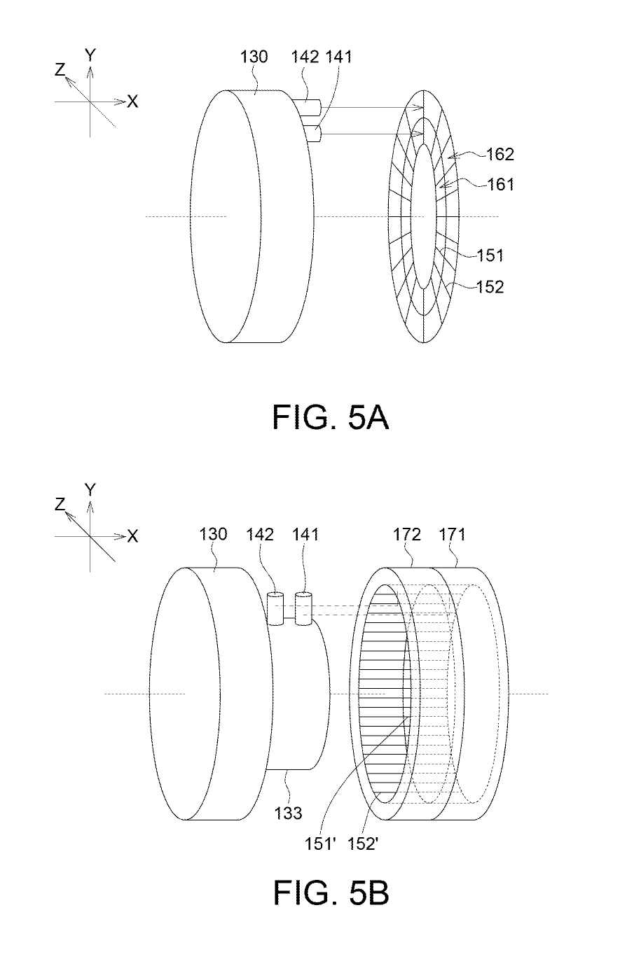

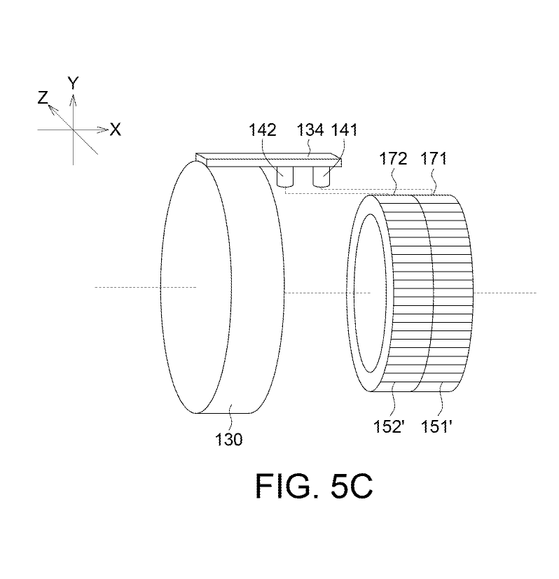

Please refer to FIGS. 1 and 5A. In one embodiment, the first wheel 110 and the second wheel 120 have a first radial surface 161 and a second radial surface 162 on a radial direction (Y direction) respectively. The first grating 151 is arranged on the first radial surface 161 and the second grating 152 is arranged on the second radial surface 162. The two optical sensors 141 and 142 are provided in correspondence to the first grating 151 and the second grating 152 in a normal direction (X direction) on the first radial surface 161 and the second radial surface 162, respectively, for receiving optical signals reflected by the first grating 151 and the second grating 152.

Next, please refer to FIGS. 1 and 5B. In another embodiment, the first wheel 110 and the second wheel 120 have a first annular surface 171 and a second annular surface 172 surrounding an axial direction (X direction) respectively. The first grating 151′ is arranged on the first annular surface 171 and the second grating 152′ is arranged on the second annular surface 172. The power module 130 has a protrusion portion 133 extending into a space surrounded by the first annular surface 171 and the second annular surface 172. The two optical sensors 141 and 142 are provided in correspondence to the first grating 151′ and the second grating 152′ in the protrusion portion 133 in the radial direction (Y direction), respectively, for receiving the optical signals reflected by the first grating 151′ and the second grating 152′.

Next, please refer to FIGS. 1 and 5C. In yet another embodiment, the first wheel 110 and the second wheel 120 have a first annular surface 171 and a second annular surface 172 surrounding the axial direction (X direction) respectively. The first grating 151′ is arranged on the first annular surface 171 and the second grating 152′ is arranged on the second annular surface 172. The power module 130 has a protrusion portion 134 extending outside the first annular surface 171 and the second annular surface 172. The two optical sensors 141 and 142 are provided in correspondence to the first grating 151′ and the second grating 152′ in the protrusion portion 134 in the radial direction (Y direction), respectively, for receiving the optical signals reflected by the first grating 151′ and the second grating 152′.

In the aforementioned embodiments, a non-contact sensing method is used, the optical sensors 141 and 142 and the module for receiving sensing signals (such as the determination element 144) are set in the power module 130. If the power module 130 has a quick release mechanism, the power module 130 may be easy to detach, thus solving the problem existing in conventional contact type sensors, which have the tendency to wearing off and being not detachable.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optical sensing device for a wheel set, comprising:
a first grating, set in a first wheel of the wheel set,
a second grating, set in a second wheel of the wheel set,
an elastic object, connected between the first and the second wheels, the elastic object being adapted for sustaining a force applied when an angle difference is formed by a rotation of the second wheel with respect to the first wheel, and
two optical sensors, set in a power module of the wheel set and provided in correspondence to the first grating and the second grating respectively, wherein the two optical sensors receive two optical signals reflected by the first grating and the second grating respectively and the two optical signals are used to calculate the angle difference.

2. The optical sensing device according to claim 1, wherein the first grating is arranged on a first radial surface of the first wheel, the second grating is arranged on a second radial surface on the second wheel, and the two optical sensors are provided in correspondence to the first grating and the second grating in a normal direction on the first and the second radial surfaces.

3. The optical sensing device according to claim 1, wherein the first wheel has a first annular surface and the second wheel has a second annular surface, the first grating is arranged on the first annular surface and the second grating is arranged on the second annular surface, the power module has a protrusion portion extending into a space surrounded by the first and the second annular surfaces, and the two optical sensors are provided in correspondence to the first and second gratings in the protrusion portion.

4. The optical sensing device according to claim 1, wherein the first wheel has a first annular surface and the second wheel has a second annular surface, the first grating is arranged on the first annular surface and the second grating is arranged on the second annular surface, the power module has a protrusion portion extending outside the first and the second annular surfaces, and the two optical sensors are provided in correspondence to the first and the second gratings in the protrusion portion.

5. The optical sensing device according to claim 1, further comprising:
a determination element, receiving the two optical signals received by the two optical sensors for calculating the numbers of lines of the first grating and the second grating and calculating a first angle and a second angle in correspondence to the numbers of lines of the first grating and the second grating respectively, wherein a difference between the first and the second angles is the angle difference.

6. The optical sensing device according to claim 5, wherein the determination element further analyzes phase changes of the optical signals reflected by the first grating and the second grating to determine directions of rotation of the first wheel and the second wheel, respectively.

7. The optical sensing device according to claim 1, wherein when the angle difference is greater than or equal to a positive threshold, the power module outputs a positive torsional force to the first wheel, when the angle difference is less than or equal to a negative threshold, the power module outputs a negative torsional force to the first wheel, and when the angle difference is between the positive and the negative thresholds, the power module does not output any torsional force to the first wheel.

8. An optical sensing method for a wheel set, wherein the wheel set comprises a first wheel, a second wheel, and a power module, a first grating is set in the first wheel, a second grating is set in the second wheel, and two optical sensors are set in the power module, the optical sensing method comprising:
receiving two optical signals reflected by the first and the second gratings by the two optical sensors, respectively, and
calculating an angle difference formed by an rotation of the second wheel with respect to the first wheel according to the two optical signals reflected by the first grating and the second grating.

9. The optical sensing method according to claim 8, further comprising calculating the numbers of lines of the first grating and the second grating, and calculating a first angle and a second angle in correspondence to the numbers of lines of the first grating and the second grating respectively, wherein a difference between the first and the second angles is the angle difference.

10. The optical sensing method according to claim 8, wherein the power module outputs a torsional force to the first wheel according to the angle difference.

11. The optical sensing method according to claim 10, wherein when the angle difference is greater than or equal to a positive threshold, the power module outputs a positive torsional force to the first wheel, when the angle difference is less than or equal to a negative threshold, the power module outputs a negative torsional force to the first wheel, and when the angle difference is between the positive and the negative thresholds, the power module does not output any torsional force to the first wheel.

12. The optical sensing method according to claim 8, further comprising determining directions of rotation of the first wheel and the second wheel according to the optical signals reflected by the first grating and the second grating, respectively.
